(19) United States
(12) Patent Application Publication
(10) Pub. No.: US 2024/0123269 A1
(43) Pub. Date: Apr. 18, 2024

(54) FIRE EXTINGUISHING NOZZLE FOR A FIRE EXTINGUISHING SYSTEM OF A WHEELED LAND VEHICLE, FIRE EXTINGUISHING SYSTEM, WHEELED LAND VEHICLE, AND METHOD OF APPLYING A FIRE EXTINGUISHING AGENT TO AN OUTSIDE ENVIRONMENT OF A WHEELED LAND VEHICLE

(71) Applicant: KIDDE-DEUGRA Brandschutzsysteme GmbH, Ratingen (DE)

(72) Inventors: Ralf W. Dreisilker, Velbert (DE); Erdinc Kacar, Krefeld (DE)

(21) Appl. No.: 18/488,630

(22) Filed: Oct. 17, 2023

(30) Foreign Application Priority Data
Oct. 18, 2022 (EP) 22202331.9

(51) Int. Cl. A62C 31/00; A62C 27/00

(52) U.S. Cl. CPC A62C 31/005; A62C 27/00

(57) ABSTRACT

A fire extinguishing nozzle for a fire extinguishing system of a wheeled land vehicles includes a mounting portion, an extinguishing agent connection, a fixed nozzle section, and moveable nozzle sections. The mounting portion mounts the fire extinguishing nozzle to an outside portion of the wheeled land vehicle. The extinguishing agent connection couples the first extinguishing nozzle to an extinguishing agent reservoir. The fixed nozzle section is fixedly mounted to the mounting portion. The moveable nozzle sections form a telescopic nozzle arrangement configured to extend from the fixed nozzle section in a telescoping manner upon receiving a pressurized extinguishing agent at the extinguishing agent connection.

### CROSS-REFERENCE TO RELATED APPLICATION(S)

This application claims the benefit of E.P. Application No. 22202331.9 filed Oct. 18, 2022 is hereby incorporated by reference in their entirety.

### BACKGROUND

The present invention is in the field of fire extinguishing systems of wheeled land vehicles. In particular, the present invention is in the field of fire extinguishing systems of armored wheeled land vehicles. Further in particular, the present invention is in the field of fire extinguishing systems of wheeled land vehicles with high ground clearance.

Modern armored wheeled land vehicles are in use both for civilian applications and military applications. Civilian applications include the transport of high profile politicians, the transport of foreign officials in politically unstable regions, the transport of international observers in areas of political crisis, etc. Military applications include the use of such vehicles as medical emergency vehicles in combat regions, as fast ground transport options in combat regions, etc. The armored wheeled land vehicles are often equipped with fire extinguishing systems. The fire extinguishing systems are primarily aimed at preventing a fire, which is present in the environment of the armored wheeled land vehicle, from taking hold of the vehicle. For example, in case of a Molotov cocktail or other burnable substance setting the ground underneath or around the vehicle on fire, the fire extinguishing system aims at fighting said fire and preventing the fire from taking hold of the vehicle. Present fire extinguishing systems are not always satisfactory in terms of their effectiveness in combatting the fire underneath the armored wheeled land vehicle.

Accordingly, it would be beneficial to provide a fire extinguishing system of a wheeled land vehicle and suitable components of the fire extinguishing system that allow for a highly effective fire fighting underneath the wheeled land vehicle.

### SUMMARY

Exemplary embodiments of the invention include a fire extinguishing nozzle for a fire extinguishing system of a wheeled land vehicle, the fire extinguishing nozzle comprising: a mounting portion for mounting the fire extinguishing nozzle to an outside portion of the wheeled land vehicle, in particular to an underbody of the wheeled land vehicle; an extinguishing agent connection for coupling the fire extinguishing nozzle to an extinguishing agent reservoir of the fire extinguishing system; a fixed nozzle section, fixedly mounted to the mounting portion; and a plurality of movable nozzle sections, movably arranged with respect to the fixed nozzle section; wherein the fixed nozzle section and the plurality of movable nozzle sections form a telescopic nozzle arrangement, wherein the plurality of movable nozzle sections are configured to extend from the fixed nozzle section in a telescoping manner upon receiving a pressurized extinguishing agent at the extinguishing agent connection.

Exemplary embodiments of the invention allow for highly effective fire fighting underneath the wheeled land vehicle. In particular, even in cases where the wheeled land vehicle is of a sports utility vehicle (SUV) type and has a high ground clearance, a highly effective fire fighting at the ground may be achieved. With the telescopic nozzle arrangement, it is possible to release the extinguishing agent close to the fire and to achieve a very direct application of extinguishing agent to the area of concern. As compared to previous approaches, where the extinguishing agent was released from close to the underbody of the wheeled land vehicle, a dispersion of the extinguishing agent by wind or fire-induced air draw may be prevented or reduced. With the telescopic nozzle arrangement, the extinguishing agent may be released close to the ground and may spread along the ground for forming an extinguishing agent layer on the ground, i.e. right at or at least close to the source of the hazardous situation.

The fixed nozzle section and the plurality of movable nozzle sections form a telescopic nozzle arrangement. It can also be said that the fire extinguishing nozzle comprises a telescopic nozzle arrangement, which in turn comprises a fixed nozzle section and a plurality of movable nozzle sections. The telescopic nozzle arrangement may allow for a distal end of the fire extinguishing nozzle to extend a substantial distance from the body of the wheeled land vehicle and to come into close proximity of the fire to be extinguished.

The plurality of movable nozzle sections are configured to extend from the fixed nozzle section in a telescoping manner upon receiving a pressurized extinguishing agent at the extinguishing agent connection. In particular, an inner space of the telescopic nozzle arrangement may be coupled to the extinguishing agent connection for receiving the pressurized extinguishing agent. Further in particular, the extinguishing agent connection of the fire extinguishing nozzle may open into/lead into the inner space of the telescopic nozzle arrangement. Accordingly, receiving the pressurized extinguishing agent at the extinguishing agent connection may immediately lead to receiving the pressurized extinguishing agent in the inner space of the telescopic nozzle arrangement. The pressure of the extinguishing agent results in the extension of the plurality of movable nozzle sections from the fixed nozzle section. The receiving of the pressurized extinguishing agent results in the plurality of movable nozzle sections to be displaced from their retracted positions/standby positions to their extended positions/operating positions. The extension of the plurality of movable nozzle sections in a telescoping manner is a passive mechanism, which takes place in response to the application of the pressure of the extinguishing agent. No active mechanism, dedicated to the extension of the plurality of movable nozzle sections, is required for bringing the fire extinguishing nozzle in its operating configuration.

The pressurized extinguishing agent may be a pressurized dry chemical extinguishing agent. Accordingly, the plurality of movable nozzle sections may be configured to extend from the fixed nozzle section in a telescoping manner upon receiving a pressurized dry chemical extinguishing agent at the extinguishing agent connection. It is also possible that the extinguishing agent is a gaseous extinguishing agent or a combination of a gaseous extinguishing agent and a dry chemical extinguishing agent. The gaseous extinguishing agent may be stored in the extinguishing agent reservoir in a liquified manner and may assume the gaseous phase upon being released from the extinguishing agent reservoir or from the fire extinguishing nozzle.

The fire extinguishing nozzle may be part of a fire extinguishing system that is de-signed particularly for a specific type of wheeled land vehicles. It is also possible that the fire extinguishing nozzle, as described herein, is provided for retrofitting existing fire extinguishing systems of wheeled land vehicles.

The wheeled land vehicle may be an armored wheeled land vehicle. Accordingly, the fire extinguishing nozzle may be a fire extinguishing nozzle for a fire extinguishing system of an armored wheeled land vehicle. The fire extinguishing nozzle may be put to particularly good use in the framework of an armored wheeled land vehicles, because armored wheeled land vehicles are often deployed in situations where a comparably high risk of fire on the ground exists. It is also possible to use the fire extinguishing nozzle in fire extinguishing systems of non-armored vehicles, such as construction vehicles or other non-armored vehicles that may be equipped with a fire extinguishing system.

The extinguishing agent connection is configured for coupling the fire extinguishing nozzle to an extinguishing agent reservoir of a fire extinguishing system of a wheeled land vehicle. The extinguishing agent connection may be configured for directly coupling the fire extinguishing nozzle to the extinguishing agent reservoir. It may also be configured for coupling the fire extinguishing nozzle to an extinguishing agent pipe or duct or hose that is provided at the location of the fire extinguishing nozzle and that runs to the extinguishing agent reservoir. In this way, the extinguishing agent reservoir may be spaced from the location of the fire extinguishing nozzle. The extinguishing agent connection may in particular be configured for receiving a pressurized dry chemical extinguishing agent in powder form. The extinguishing agent connection may have a cross section that allows for the dry chemical powder to pass through the extinguishing agent connection and to build up the pressure within the telescopic nozzle arrangement for achieving the extension of the plurality of movable nozzle sections from the fixed nozzle section.

According to a further embodiment, the plurality of movable nozzle sections are between 2 and 5 movable nozzle sections. In particular, the plurality of movable nozzle sections may be 3 or 4 movable nozzle sections. With the given numbers of movable nozzle sections, a particularly beneficial trade-off between a small height of the fire extinguishing nozzle, when the plurality of movable nozzle sections are in their retracted positions, a suitable extension towards the ground/towards the fire, when the fire extinguishing nozzle is arranged at the underbody of the wheeled land vehicle and the plurality of movable nozzle sections are in their extended positions, and a manageable mechanical complexity may be achieved.

According to a further embodiment, the plurality of movable nozzle sections are located inside the fixed nozzle section, when in their retracted positions. In this way, the fixed nozzle section may form an effective protection of the telescoping mechanism of the telescopic nozzle arrangement. Also, extinguishing agent release openings, which are provided on one or more of the movable nozzle sections, may be effectively protected from environmental influences, when located inside the fixed nozzle section prior to use of the fire extinguishing nozzle. The plurality of movable nozzle sections may be located fully inside the fixed nozzle section or may be located partially inside the fixed nozzle section, when in their retracted positions. In other words, the plurality of movable nozzle sections may extend somewhat out from the fixed nozzle section, when in their retracted positions, or not. In yet other words, the fixed nozzle section may surround the peripheral side faces of the movable nozzle sections entirely, when the movable nozzle sections are in their retracted positions, or may partially surround the peripheral side faces of the movable nozzle sections.

According to a further embodiment, the fire extinguishing nozzle has a total height of between 3 cm and 10 cm, in particular of between 5 cm and 8 cm, when the plurality of movable nozzle sections are in their retracted positions. With the given values, a particularly low impact on the ground clearance of the armored wheeled land vehicle may be achieved, when the plurality of movable nozzle sections are in their retracted positions, i.e. when the fire extinguishing nozzle is not in its operating configuration.

According to a further embodiment, the fire extinguishing nozzle has a total height of between 10 cm and 60 cm, in particular of between 20 cm and 40 cm, further in particular of between 25 cm and 35 cm, when the plurality of movable nozzle sections are in their extended positions. With the given values, a particularly direct ap-plication of the extinguishing agent to the fire on the ground may be achieved.

By combining the given values for the fire extinguishing nozzle in the non-operating configuration and the operating configuration, a particularly beneficial trade-off between a low impact on the normal driving operation of the wheeled land vehicle and a highly effective fire fighting by the fire extinguishing system in a potentially dangerous fire situation may be achieved.

According to a further embodiment, the fixed nozzle section and the plurality of movable nozzle sections have a generally cylindrical shape. In particular, each of the fixed nozzle section and the plurality of movable nozzle sections may have the form of a hollow cylinder section. In this way, the plurality of movable nozzle sections may be particularly well-suited for extending from the fixed nozzle section in a telescoping manner, while maintaining a high degree of stability along the telescopic nozzle arrangement. Also, the generally cylindrical shape may be particularly well-suited for responding to the pressure of the extinguishing agent and resulting in the extension of the plurality of movable nozzle sections in a telescoping manner. The generally cylindrical shape refers to a geometry of the fixed nozzle section and the movable nozzle sections that is substantially circular in cross-section. It is, however, pointed out that other cross-sections, such as elliptical or polygonal cross-sections, e.g. square or rectangular cross-sections, are possible as well.

According to a further embodiment, the plurality of movable nozzle sections have a distal nozzle section, which is spaced farthest from the fixed nozzle section, when the plurality of movable nozzle sections are in their extended positions; wherein the distal nozzle section has a distal end face and a peripheral side face; and wherein at least one first extinguishing agent release opening is provided on the distal end face and a plurality of second extinguishing agent release openings are provided around the peripheral side face. With the provision of extinguishing agent release openings on the distal end face and on the peripheral side face, a highly effective multi-dimensional application of extinguishing agent to the fire may be achieved. Also, by having the extinguishing agent release openings distributed between the distal end face and the peripheral side face, a beneficial build-up of pressure, including an effective use of said pressure for extending the plurality of movable nozzle sections, may be achieved upon receiving the pressurized extinguishing agent. Moreover, the extinguishing agent release openings around the peripheral side face may be well-protected, as long as the plurality of movable nozzle sections are in their retracted positions. In this way, at least the plurality of second extinguishing agent release openings are fully operational in the case of a fire, irrespective of whether the at least one first extinguishing agent release opening has been blocked by dirt/has been tampered with/has experienced mechanical damage or not. The at least one first extinguishing agent release opening may also be protected by a protective cap, with the release of the extinguishing agent popping the protective cap off of the fire extinguishing nozzle.

According to a further embodiment, the plurality of second extinguishing agent release openings are provided all around the peripheral side face of the distal nozzle section. It is also possible that the plurality of second extinguishing agent release openings are provided around a portion of the peripheral side face of the distal nozzle section, such as around 180° or around another limited angular range of the peripheral side face of the distal nozzle section.

According to a further embodiment, each of the at least one first extinguishing agent release opening and/or each of the plurality of second extinguishing release openings has a cross-section of between 2 mm and 4 mm, in particular a cross-section of about 3 mm.

While the provision of at least one extinguishing agent release opening on the distal end face and of a plurality of second extinguishing agent release openings around the peripheral side face may be beneficial, it is also possible that extinguishing agent release openings are only provided on the distal end face or only provided on the peripheral side face of the distal nozzle section. It is also possible that further extinguishing agent release openings are provided on one or more other movable nozzle sections and/or on the fixed nozzle section, in particular on the peripheral side face of one or more other movable nozzle sections and/or the fixed nozzle section. For example, extinguishing agent release openings may be provided on a subset of the plurality of movable nozzle sections.

According to a further embodiment, the total cross-section of the plurality of second extinguishing agent release openings is at least two times the total cross-section of the at least one first extinguishing agent release opening, in particular at least three times the total cross-section of the at least one first extinguishing agent release opening, further in particular between three times and five times the total cross-section of the at least one first extinguishing agent release opening. With the given ratios, a particularly beneficial trade-off between a good pressure build-up within the telescopic nozzle arrangement and, thus, good extension characteristics of the plurality of movable nozzle sections on the one hand and good extinguishing agent application characteristics on the other hand may be achieved.

According to a further embodiment, the at least one first extinguishing agent release opening comprises between 1 and 20 first extinguishing agent release openings, in particular between 4 and 10 first extinguishing agent release openings. In other words, between 1 and 20 first extinguishing agent release openings, in particular between 4 and 10 first extinguishing agent release openings extinguishing agent release openings, are provided on the distal end face of the distal nozzle section.

According to a further embodiment, the plurality of second extinguishing agent release openings comprises between 2 and 30 second extinguishing agent release openings, in particular between 4 and 16 second extinguishing agent release openings. In other words, between 2 and 30 second extinguishing agent release openings, in particular between 4 and 16 second extinguishing agent release openings, are provided on the peripheral side face of the distal nozzle section.

According to a further embodiment, the plurality of movable nozzle sections are configured to extend from the fixed nozzle section in a telescoping manner upon receiving a pressurized dry chemical extinguishing agent. In particular, the plurality of movable nozzle sections may be configured to extend from the fixed nozzle section in a telescoping manner upon receiving a pressurized dry chemical extinguishing agent with an extinguishing agent pressure of at least 15 bar, in particular with an extinguishing agent pressure of between 15 bar and 30 bar. In this way, the telescopic nozzle arrangement is particularly well-suited for working with common dry chemical pressures in fire extinguishing systems. In particular, the fire extinguishing nozzle may be conveniently integrated into fire extinguishing systems that operate at such common extinguishing agent pressures, without particular adaptations to the fire extinguishing system being mandated.

According to a further embodiment, the plurality of movable nozzle sections are configured to extend from the fixed nozzle section in a telescoping manner upon receiving a pressurized extinguishing agent with an extinguishing agent pressure of at least 15 bar, in particular with an extinguishing agent pressure of between 15 bar and 30 bar.

According to a further embodiment, the mounting portion comprises a mounting plate. The mounting plate may be a circular mounting plate. It may also have another geometry, such as a square or rectangular geometry. With the mounting plate, the fire extinguishing nozzle may be attached to an outside portion of the wheeled land vehicle in a particularly stable manner. In particular, the fire extinguishing nozzle may be mounted to the underbody of the wheeled land vehicle in a particularly stable manner. It is also possible to mount the fire extinguishing nozzle to other outside portions of the wheeled land vehicle. For example, the fire extinguishing nozzle may be arranged in a suitable position in the engine compartment of the wheeled land vehicle. In this case, the telescoping extension of the telescopic nozzle arrangement may allow for the application of the extinguishing agent in a particularly dedicated manner at locations within the engine compartment that are particularly susceptible to hazardous fire development.

According to a further embodiment, the extinguishing agent connection is a through hole through the mounting plate. In this way, the mounting portion and the extinguishing agent connection may be beneficially integrated into a single component. It is also possible that the extinguishing agent connection is provided at another component of the fire extinguishing nozzle. For example, the extinguishing agent connection may be provided in the peripheral side face of the fixed nozzle section. It is also possible that the mounting plate is equipped with a protruding flange and that the extinguishing agent connection is provided in a peripheral side face of the protruding flange.

Exemplary embodiments of the invention further include a fire extinguishing system for a wheeled land vehicle, the fire extinguishing system comprising: an extinguishing agent reservoir; and at least one fire extinguishing nozzle in accordance with any of the embodiments described above, coupled to the extinguishing agent reservoir. The additional features, modifications and effects, as described above with respect to the fire extinguishing nozzle, apply to the fire extinguishing system in an analogous manner. The at least one fire extinguishing nozzle may be directly coupled to the extinguishing agent reservoir or may be coupled to the extinguishing agent reservoir via an extinguishing agent pipe/an extinguishing agent duct/an extinguishing agent hose. In particular, for each of the at least one fire extinguishing nozzle, the extinguishing agent connection may be coupled to the extinguishing agent reservoir. The fire extinguishing system may have exactly one fire extinguishing nozzle, as described herein, or may have a plurality of fire extinguishing nozzles, as described herein. Also, the fire extinguishing system may be a distributed system having a plurality of extinguishing agent reservoirs and a plurality of fire extinguishing nozzles. Yet further, the fire extinguishing system may have other extinguishing agent outlets than the one or more fire extinguishing nozzles, as described herein. In particular, the fire extinguishing system may be configured to serve various different fire fighting tasks within the wheeled land vehicle. The wheeled land vehicle may be an armored wheeled land vehicle. Accordingly, the fire extinguishing system may be a fire extinguishing system for an armored wheeled land vehicle.

According to a further embodiment, the fire extinguishing system further comprises a trigger mechanism configured to establish a respective agent receiving path between the extinguishing agent reservoir and each of the at least one fire extinguishing nozzle. The trigger mechanism may be configured as follows. Prior to detecting an emergency situation, in which the fire extinguishing system is to be operated, the at least one fire extinguishing nozzle may be coupled to the extinguishing agent reservoir, but may be cut off from actually receiving the extinguishing agent from the extinguishing agent reservoir. In other words, no pressurized extinguishing agent is present within the at least one fire extinguishing nozzle at that stage. With the trigger mechanism, actual agent receiving path(s) between the extinguishing agent reservoir and the fire extinguishing nozzle(s) is/are established. In other words, when the fire extinguishing system starts to operate, the extinguishing agent reaches the at least one fire extinguishing nozzle from the extinguishing agent reservoir. The trigger mechanism may be a membrane tearing mechanism that destroys one or more blocking membranes along the way from the extinguishing agent reservoir to the one or more fire extinguishing nozzles. Any other suitable kind of trigger mechanism is possible as well.

Exemplary embodiments of the invention further include a wheeled land vehicle, comprising a fire extinguishing system in accordance with any of the embodiments described above, wherein the at least one fire extinguishing nozzle is arranged on one or more outside portions of the wheeled land vehicle. The additional features, modifications and effects, as described above with respect to the fire extinguishing nozzle and/or with respect to the fire extinguishing system, apply to the wheeled land vehicle in an analogous manner.

According to a further embodiment, the wheeled land vehicle is an armored wheeled land vehicle, and the at least one fire extinguishing nozzle is arranged on one or more outside portions of the armored wheeled land vehicle.

According to a further embodiment, the at least one fire extinguishing nozzle is arranged on an underbody of the wheeled land vehicle, with a direction of extension of the telescopic nozzle arrangement of the at least one fire extinguishing nozzle being substantially downward from the underbody of the wheeled land vehicle. In particular, the direction of extension of the telescopic nozzle arrangement may be substantially vertical in the frame of reference of the wheeled land vehicle. In this way, the distal end of the telescopic nozzle arrangement may be located close to the ground underneath the wheeled land vehicle and may be well-positioned for applying the extinguishing agent to the fire on the ground. It is again pointed out that the fire extinguishing system may have fire extinguishing nozzles on other portions of the wheeled land vehicle and may additionally serve other purposes than to combat fire on the ground.

According to a further embodiment, the extinguishing agent reservoir is within an armored portion of an armored wheeled land vehicle, and the at least one fire extinguishing nozzle is outside of the armored portion of the armored wheeled land vehicle. In this case, the at least one fire extinguishing nozzle may be coupled to the extinguishing agent reservoir via at least one extinguishing agent pipe/duct/hose. Such pipe/duct/hose may extend from the location of the at least one fire extinguishing nozzle outside of the armored portion of the armored wheeled land vehicle to the extinguishing agent reservoir within the armored portion of the armored wheeled land vehicle.

Exemplary embodiments of the invention further include a method of applying a fire extinguishing agent to an outside environment of a wheeled land vehicle, that method comprising: providing a pressurized extinguishing agent to a fire extinguishing nozzle, which comprises a fixed nozzle section and a plurality of movable nozzle sections; as a response to receiving the pressurized extinguishing agent, extending the plurality of movable nozzle sections from the fixed nozzle section in a tele-scoping manner; and releasing the pressurized extinguishing agent from the fire extinguishing nozzle. The additional features, modifications and effects, as described above with respect to the fire extinguishing nozzle and/or the fire extinguishing system and/or the wheeled land vehicle, apply to the method of applying a fire extinguishing agent to an outside environment of a wheeled land vehicle in an analogous manner.

According to a further embodiment, said releasing of the pressurized extinguishing agent comprises releasing the pressurized extinguishing agent from a distal nozzle section, which is spaced farthest from the fixed nozzle section when the plurality of movable nozzle sections are in their extended positions.

Further exemplary embodiments of the invention are described with respect to the accompanying drawings, wherein:

### BRIEF DESCRIPTION OF THE DRAWINGS

FIG. 1 shows a wheeled land vehicle in accordance with an exemplary embodiment of the invention, equipped with a fire extinguishing system in accordance with an exemplary embodiment of the invention, in a schematic side view.

FIG. 2 shows the wheeled land vehicle of FIG. 1 in the same schematic side view, with the fire extinguishing system being deployed for a fire fighting operation.

FIG. 3 shows a fire extinguishing nozzle in accordance with an exemplary embodiment of the invention in a perspective, partially cut-open schematic view.

FIG. 4 shows the fire extinguishing nozzle of FIG. 3 in another perspective view, with the telescopic nozzle arrangement being in its extended position.

FIG. 5 shows the fire extinguishing nozzle of FIG. 4 in a cross-sectional view.

### DETAILED DESCRIPTION

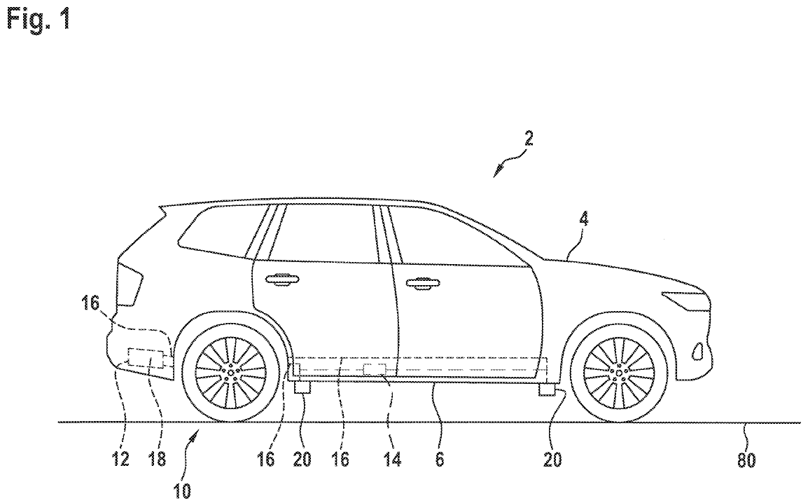

FIG. 1 shows a wheeled land vehicle 2 in accordance with an exemplary embodiment of the invention in a schematic side view. In the exemplary embodiment of FIG. 1, the wheeled land vehicle 2 is a sports utility vehicle (SUV) type vehicle. The wheeled land vehicle may also be another type of vehicle, such as a construction vehicle or another type of vehicle. In the exemplary embodiment of FIG. 1, the wheeled land vehicle 2 is an armored wheeled land vehicle and is referred to as such below. It is stressed, however, that the wheeled land vehicle 2 may also be a non-armored wheeled land vehicle.

The armored wheeled land vehicle 2 has an armored body 4. This armored body 4 is supported on the ground 80 by four wheels 8, two of which are shown in the side view of FIG. 1. As part of the armored body 4, the armored wheeled land vehicle 2 has an armored underbody 6, i.e. an armored underside of the armored wheeled land vehicle 2/of the armored body 4. Being an SUV-type vehicle, the armored wheeled land vehicle 2 has a comparably large ground clearance, i.e. a comparably large distance between the armored underbody 6 and the ground 80.

The armored wheeled land vehicle 2 is equipped with a fire extinguishing system 10 in accordance with an exemplary embodiment of the invention. The fire extinguishing system 10 comprises an extinguishing agent reservoir 12, which is arranged within a rear portion of the armored body 4 in the exemplary embodiment of FIG. 1. The extinguishing agent reservoir 12 is filled with a pressurized dry chemical extinguishing agent 18. In particular, the extinguishing agent reservoir 12 may be filled with a dry chemical extinguishing agent having a pressure of about 25 bar. The extinguishing agent may be an ABC powder or a BC powder or any other suitable kind of dry chemical extinguishing agent.

The fire extinguishing system 10 further comprises a plurality of fire extinguishing nozzles 20. In the schematic representation of FIG. 1, two such fire extinguishing nozzles 20 are depicted. In particular, a fire extinguishing nozzle is arranged slightly reward of the front wheels of the armored wheeled land vehicle 2, and another fire extinguishing nozzle is arranged slightly forward of the rear wheels of the armored wheeled land vehicle 2. It is understood that fewer or more fire extinguishing nozzles 20 may be provided and that the fire extinguishing nozzle(s) may be provided at different locations of the armored wheeled land vehicle 2 than the ones depicted in FIG. 1. The two fire extinguishing nozzles 20 of FIG. 1 are fire extinguishing nozzles in accordance with an exemplary embodiment of the invention, as will described in more detail below.

Each of the fire extinguishing nozzles 20 is coupled to the extinguishing agent reservoir 12 via a respective extinguishing agent pipe 16. When the fire extinguishing system 10 is activated, the extinguishing agent pipes 16 establish an agent receiving path for the fire extinguishing nozzles 20, through which the fire extinguishing nozzles 20 are provided with extinguishing agent 18 from the extinguishing agent reservoir 12.

The fire extinguishing system 10 further comprises a control unit 14. The control unit 14 may activate the fire extinguishing system 10 upon receiving an according indication and/or an according command signal. For example, the control unit 14 may be coupled to fire detection sensors at the armored underbody 6 of the armored wheeled land vehicle 2 and/or may be coupled to a board computer that dis-tributes a fire alarm signal throughout the armored wheeled land vehicle 2. When activating the fire extinguishing system 10, the control unit 14 may activate suitable trigger mechanism(s). For example, the control unit 14 may cause extinguishing agent blockers within the extinguishing agent pipes 16 to be removed/destroyed and may, thus, initiate an actual provision of the dry chemical extinguishing agent 18 to the fire extinguishing nozzles 20.

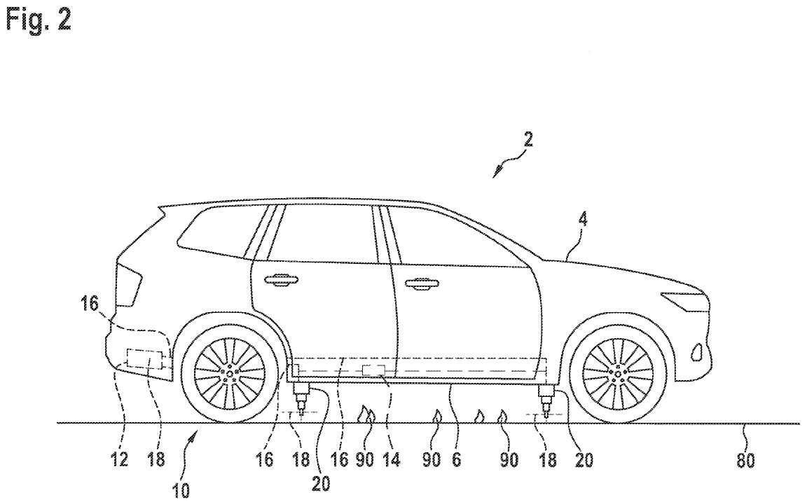

FIG. 2 shows the wheeled land vehicle 2 in the same schematic side view as FIG. 1, with the fire extinguishing system 10 being activated. In particular, FIG. 2 shows the wheeled land vehicle 2 in a situation where a fire 90 is present on the ground 80 underneath the wheeled land vehicle 2.

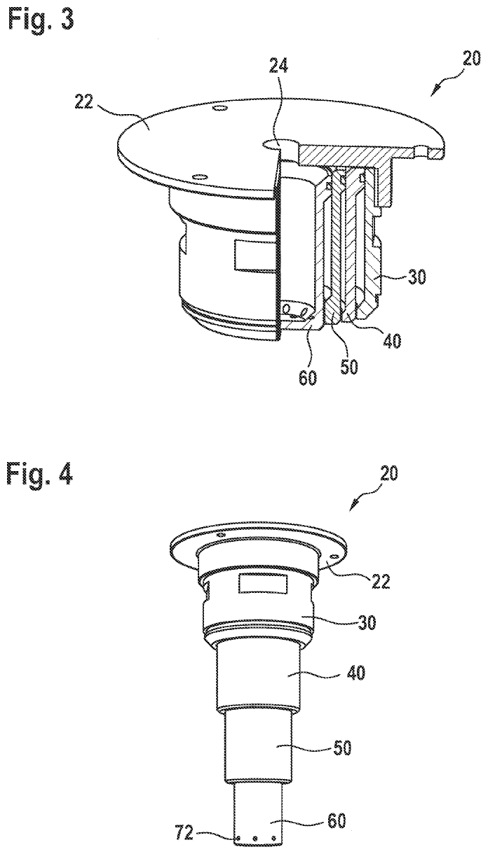

When the fire extinguishing system 10 is activated, the telescopic nozzle arrangement of each of the fire extinguishing nozzles 20 assumes an extended configuration. In particular, for each of the fire extinguishing nozzles 20, a plurality of movable nozzle sections, which had been arranged within a fixed nozzle section, as depicted in FIG. 1, now extend downward from the fixed nozzle section. The fixed nozzle section forms a proximate end portion of the fire extinguishing nozzle 20 at the armored underbody 6. The plurality of movable nozzle sections allow for a distal end portion of the fire extinguishing nozzle 20 to reach close to the ground 80. In this way, the fire extinguishing nozzles 20 are able to combat the fire 90 very directly in close proximity to the ground 80. The fire fighting operation is illustrated in FIG. 2 by the schematic representation of a spray of extinguishing agent 18 that leaves the distal end portions of the fire extinguishing nozzles 20. A detailed description of a fire extinguishing nozzle 20 in accordance with an exemplary embodiment of the invention will be given below with respect to FIGS. 3, 4 and 5.

FIG. 3 shows a fire extinguishing nozzle 20 in accordance with an exemplary embodiment of the invention in a perspective, partially cut-open schematic view. The fire extinguishing nozzle 20 is depicted in a configuration, before the fire extinguishing system is activated. It can also be said that the fire extinguishing nozzle 20 is shown in a standby configuration/non-operating configuration in FIG. 3.

The fire extinguishing nozzle 20 comprises a mounting portion 22. In the exemplary embodiment of FIG. 3, the mounting portion 22 comprises a circular mounting plate and a hollow cylindrical flange, protruding from the circular mounting plate. With said circular mounting plate, the fire extinguishing nozzle 20 may be mounted to the underbody of an armored wheeled land vehicle, as for example depicted in FIGS. 1 and 2. It may also be mounted to the underbody of a non-armored wheeled land vehicle or may be mounted to another outside portion of a wheeled land vehicle.

The fire extinguishing nozzle 20 further comprises an extinguishing agent connection 24. In the exemplary embodiment of FIG. 3, the extinguishing agent connection 24 is a through hole through the mounting portion 22. In particular, the extinguishing agent connection 24 is a through hole through the center of the mounting portion 22. When being part of the fire extinguishing system 10 of FIGS. 1 and 2, the extinguishing agent connection 24 is coupled to an extinguishing agent pipe 16, through which the fire extinguishing nozzle 20 receives the extinguishing agent 18 in operation.

The fire extinguishing nozzle 20 comprises a telescopic nozzle arrangement. This telescopic nozzle arrangement comprises a fixed nozzle section 30, a first movable nozzle section 40, a second movable nozzle section 50, and a third movable nozzle section 60. The fixed nozzle section 30 has a fixed position with respect to the mounting portion 22 of the fire extinguishing nozzle 20. In particular, the fixed nozzle section 30 is fixed in position/mounted to the cylindrical flange of the mounting portion 22 in the exemplary embodiment of FIG. 3. The first, second, and third movable nozzle sections 40, 50, 60 are movable with respect to the fixed nozzle section 30 and are, thus, movable with respect to the mounting portion 22.

In FIG. 3, the first, second, and third movable nozzle section 40, 50, 60 are depicted in their retracted positions. In the retracted positions, the first, second and third movable nozzle sections 40, 50, 60 are arranged on the inside of the fixed nozzle section 30. In the exemplary embodiment of FIG. 3, the fixed nozzle section 30 and the first, second, and third movable nozzle sections 40, 50, 60 are concentric, hollow-cylindrical structures. It can also be said that the fixed nozzle section 30, the first movable nozzle section 40, the second movable nozzle section 50, and the third movable nozzle section 60 are pipe sections of varying diameters. The extinguishing agent connection 24 opens into the inner space of the third movable nozzle section 60.

In the exemplary embodiment of FIG. 3, the fire extinguishing nozzle 20 has a total height of slightly below 10 cm, when the first, second, and third movable nozzle sections 40, 50, 60 are in their depicted retracted positions.

FIG. 4 shows the fire extinguishing nozzle 20 of FIG. 3 in another perspective view, with the telescopic nozzle arrangement being in an extended configuration. In particular, in the depicted configuration of FIG. 4, the first movable nozzle section 40, the second movable nozzle section 50, and the third movable nozzle section 60 are displaced from their standby positions, as depicted in FIG. 3; they are depicted in their extended positions. Further in particular, the first movable nozzle section 40, the second movable nozzle section 50, and the third movable nozzle section 60 are shown as extending from the fixed nozzle section 30 in a telescoping manner. Accordingly, the first movable nozzle section 40 is located adjacent to the fixed nozzle section 30, the second movable nozzle section 50 is located adjacent to the first movable nozzle section 40, and the third movable nozzle section 60 is located adjacent to the second movable nozzle section 50 in the direction of extension.

The fixed nozzle section 30, the first movable nozzle section 40, the second movable nozzle section 50, and the third movable nozzle section 60 form an extinguishing agent pipe that has a decreasing diameter from its proximate end portion, i.e. from its end portion at the mounting portion 22, to its distal end portion. At the third movable nozzle section 60, a plurality of extinguishing agent release openings 72, which will be described in more detail below, are provided.

In the extended configuration depicted in FIG. 4, the fire extinguishing nozzle 20 has a total height of about 30 cm. In this way, the extinguishing agent release openings 72 may be brought in close proximity to a fire that is present on the ground underneath an armored wheeled land vehicle and that is to be extinguished by the fire extinguishing system of the armored wheeled land vehicle.

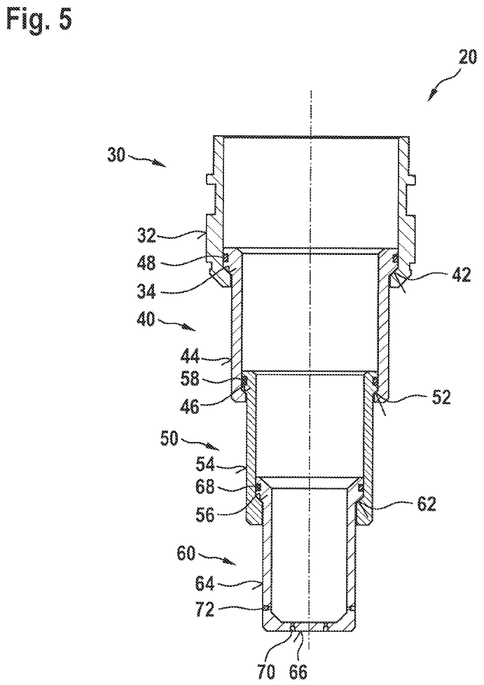

FIG. 5 shows the fire extinguishing nozzle 20 of FIGS. 3 and 4 in the extended configuration of FIG. 4 in a cross-sectional view. The depicted cross-sectional plane is a vertical cross-sectional plane, when the fire extinguishing nozzle 20 is mounted to the underbody of an armored wheeled land vehicle. As compared to FIGS. 3 and 4, additional constructional detail of the fire extinguishing nozzle 20 is described with respect to FIG. 5. For ease of representation, the mounting portion 22 is omitted from FIG. 5.

The fixed nozzle section 30 has a peripheral side face 32 and a distal stop surface 34. The first movable nozzle section 40 has a proximate stop surface 42, a peripheral side face 44, and a distal stop surface 46. The second movable nozzle section 50 has a proximate stop surface 52, a peripheral side face 54, and a distal stop surface 56. The third movable nozzle section 60 has a proximate stop surface 62, a peripheral side face 64, and a distal end face 66.

In the extended configuration depicted in FIG. 5, the proximate stop surface 42 of the first movable nozzle section 40 abuts the distal stop surface 34 of the fixed nozzle section 30, the proximate stop surface 52 of the second movable nozzle section 50 abuts the distal stop surface 46 of the first movable nozzle section 40, and the proximate stop surface 62 of the third movable nozzle section 60 abuts the distal stop surface 56 of the second movable nozzle section 50. A first O-ring 48 provides an extinguishing agent seal between the fixed nozzle section 30 and the first movable nozzle section 40. A second O-ring 58 provides an extinguishing agent seal between the first movable nozzle section 40 and the second movable nozzle section 50. A third O-ring 68 provides an extinguishing agent seal between the second movable nozzle section 50 and the third movable nozzle section 60. In this way, well-defined relative positions between the fixed nozzle section 30 and the first, second, and third movable nozzle sections 40, 50, 60 as well as an effective sealing at the interfaces between the nozzle sections may be achieved.

The third movable nozzle section 60 has a first plurality of extinguishing agent release openings 70 in the distal end face 66 and a second plurality of extinguishing agent release openings 72 in the peripheral side face 64. The first plurality of extinguishing agent release openings 70 are distributed across the distal end face 66, such as in a circular arrangement around a center axis through the distal end face 66. The second plurality of extinguishing agent release openings 72 are arranged around the peripheral side face 64, e.g. in an equidistant manner around the circumference of the peripheral side face 64. With the first and second pluralities of extinguishing agent release openings 70, 72, a multi-dimensional, distributed application of extinguishing agent onto the fire on the ground may be achieved. The extinguishing agent may form a kind of extinguishing agent layer on the ground and may be highly effective in combatting the fire.

The telescopic nozzle arrangement of the fixed nozzle section 30 and the first, second, and third nozzle sections 40, 50, 60 assumes the extended configuration, as shown in FIGS. 4 and 5, in response to receiving pressurized dry chemical extinguishing agent at the extinguishing agent connection 24. In particular, the nozzle sections and the sealing means between the nozzle sections may provide for such a level of friction that they remain in the retracted configuration, as depicted in FIG. 3, in the absence of pressurized dry chemical extinguishing agent and that they assume the extended configuration, as depicted in FIGS. 4 and 5, upon receiving pressurized dry chemical extinguishing agent, in particular dry chemical extinguishing agent at a pressure of between 20 bar and 30 bar. In this way, the telescoping extension is a passive reaction of the fire extinguishing nozzle 20 to the application of common dry chemical extinguishing agent pressures. No active extension mechanism is required.

### Discussion of Possible Embodiments

The following are non-exclusive descriptions of possible embodiments of the present invention.

### Fire Extinguishing Nozzle

A fire extinguishing nozzle for a fire extinguishing system of a wheeled land vehicle according to an example embodiment of this disclosure, among other possible things includes a mounting portion, an extinguishing agent connection, a fixed nozzle section, and a plurality of moveable nozzle sections. The fixed nozzle section is fixedly mounted to the mounting portion. The plurality of movable nozzle sections are moveable arranged with respect to the fixed nozzle section. The fixed nozzle section and the plurality of moveable nozzle sections form a telescopic nozzle arrangement in which the plurality of movable nozzle sections are configured to extend from the fixed nozzle section in a telescoping manner upon receiving a pressurized extinguishing agent at the extinguishing agent connection.

The fire extinguishing nozzle of the preceding paragraph can optionally include, additionally and/or alternatively, any one or more of the following features, configurations and/or additional components.

A further example of the foregoing fire extinguishing nozzle, wherein the mounting portion can mount the fire extinguishing nozzle to an outside portion of a wheeled land vehicle.

A further example of any of the foregoing fire extinguishing nozzles, wherein the extinguishing agent connection can couple the fire extinguishing nozzle to an extinguishing agent reservoir of a fire extinguishing system.

A further example of any of the foregoing fire extinguishing nozzles, wherein the plurality of movable nozzle sections can include between 2 and 5 movable nozzle sections.

A further example of any of the foregoing fire extinguishing nozzles, wherein the plurality of movable nozzle sections can include between 3 and 4 movable nozzle sections.

A further example of any of the foregoing fire extinguishing nozzles, wherein the mounting portion can mount the fire extinguishing nozzle to an underbody of the wheeled land vehicle.

A further example of any of the foregoing fire extinguishing nozzles, wherein the plurality of movable nozzle sections can be located inside the fixed nozzle section, when in their retracted positions.

A further example of any of the foregoing fire extinguishing nozzles, wherein the fire extinguishing nozzle can have a total height of between 3 cm and 10 cm, when the plurality of movable nozzle sections are in their retracted positions.

A further example of any of the foregoing fire extinguishing nozzles, wherein the fire extinguishing nozzle can have a total height of between 5 cm and 8 cm, when the plurality of movable nozzle sections are in their retracted positions.

A further example of any of the foregoing fire extinguishing nozzles, wherein the fire extinguishing nozzle can have a total height of between 10 cm and 60 cm, when the plurality of movable nozzle sections are in their extended positions.

A further example of any of the foregoing fire extinguishing nozzles, wherein the fire extinguishing nozzle can have a total height of between 20 cm and 40 cm, when the plurality of movable nozzle sections are in their extended positions.

A further example of any of the foregoing fire extinguishing nozzles, wherein the fire extinguishing nozzle can have a total height of between 25 cm and 35 cm, when the plurality of movable nozzle sections are in their extended positions.

A further example of any of the foregoing fire extinguishing nozzles, wherein the fixed nozzle section and the plurality of movable nozzle sections can have a generally cylindrical shape.

A further example of any of the foregoing fire extinguishing nozzles, wherein the plurality of movable nozzle sections can have a distal nozzle section, which is spaced farthest from the fixed nozzle section when the plurality of movable nozzle sections are in their extended positions.

A further example of any of the foregoing fire extinguishing nozzles, wherein the distal nozzle section can have a distal end face and a peripheral side face.

A further example of any of the foregoing fire extinguishing nozzles, wherein at least one first extinguishing agent release opening can be provided on the distal end face.

A further example of any of the foregoing fire extinguishing nozzles, wherein a plurality of second extinguishing agent release openings can be provided around the peripheral side face.

A further example of any of the foregoing fire extinguishing nozzles, wherein the total cross-section of the plurality of second extinguishing agent release openings can be at least two times the total cross-section of the at least one first extinguishing agent release opening.

A further example of any of the foregoing fire extinguishing nozzles, wherein the total cross-section of the plurality of second extinguishing agent release openings can be at least three times the total cross-section of the at least one first extinguishing agent release opening.

A further example of any of the foregoing fire extinguishing nozzles, wherein the total cross-section of the plurality of second extinguishing agent release openings can be between three times and five times the total cross-section of the at least one first extinguishing agent release opening.

A further example of any of the foregoing fire extinguishing nozzles, wherein the at least one first extinguishing agent release opening can include between 1 and 20 first extinguishing agent release openings.

A further example of any of the foregoing fire extinguishing nozzles, wherein the at least one first extinguishing agent release opening can include between 4 and 10 first extinguishing agent release openings.

A further example of any of the foregoing fire extinguishing nozzles, wherein the plurality of second extinguishing agent release openings can include between 2 and 30 second extinguishing agent release openings.

A further example of any of the foregoing fire extinguishing nozzles, wherein the plurality of second extinguishing agent release openings can include between 4 and 16 second extinguishing agent release openings.

A further example of any of the foregoing fire extinguishing nozzles, wherein the plurality of movable nozzle sections can be configured to extend from the fixed nozzle section in a telescoping manner upon receiving a pressurized dry chemical extinguishing agent.

A further example of any of the foregoing fire extinguishing nozzles, wherein the plurality of movable nozzle sections can be configured to extend from the fixed nozzle section in a telescoping manner upon receiving a pressurized extinguishing agent with an extinguishing agent pressure of at least 15 bar.

A further example of any of the foregoing fire extinguishing nozzles, wherein the plurality of movable nozzle sections can be configured to extend from the fixed nozzle section in a telescoping manner upon receiving an extinguishing agent pressure of between 15 bar and 30 bar.

A further example of any of the foregoing fire extinguishing nozzles, wherein the mounting portion can include a mounting plate.

A further example of any of the foregoing fire extinguishing nozzles, wherein the extinguishing agent connection can be a through hole through the mounting plate.

Fire Extinguishing System

A fire extinguishing system in accordance with an example embodiment of this disclosure includes, among other possible things, an extinguishing agent reservoir and at least one fire extinguishing nozzle coupled to the extinguishing agent reservoir. The fire extinguishing nozzle includes a mounting portion, an extinguishing agent connection, a fixed nozzle section, and a plurality of moveable nozzle sections. The fixed nozzle section is fixedly mounted to the mounting portion. The plurality of movable nozzle sections are moveable arranged with respect to the fixed nozzle section. The fixed nozzle section and the plurality of moveable nozzle sections form a telescopic nozzle arrangement in which the plurality of movable nozzle sections are configured to extend from the fixed nozzle section in a telescoping manner upon receiving a pressurized extinguishing agent at the extinguishing agent connection.

The fire extinguishing system of the preceding paragraph can optionally include, additionally and/or alternatively, any one or more of the following features, configurations and/or additional components.

A further example of the foregoing fire extinguishing system can include a trigger mechanism configured to establish a respective agent receiving path between the extinguishing agent reservoir and each of the at least one fire extinguishing nozzle.

A further example of any of the foregoing fire extinguishing systems, wherein the mounting portion can mount the fire extinguishing nozzle to an outside portion of a wheeled land vehicle.

A further example of any of the foregoing fire extinguishing systems, wherein the extinguishing agent connection can couple the fire extinguishing nozzle to an extinguishing agent reservoir of a fire extinguishing system.

A further example of any of the foregoing fire extinguishing systems, wherein the plurality of movable nozzle sections can include between 2 and 5 movable nozzle sections.

A further example of any of the foregoing fire extinguishing systems, wherein the plurality of movable nozzle sections can include between 3 and 4 movable nozzle sections.

A further example of any of the foregoing fire extinguishing systems, wherein the mounting portion can mount the fire extinguishing nozzle to an underbody of the wheeled land vehicle.

A further example of any of the foregoing fire extinguishing systems, wherein the plurality of movable nozzle sections can be located inside the fixed nozzle section, when in their retracted positions.

A further example of any of the foregoing fire extinguishing systems, wherein the fire extinguishing nozzle can have a total height of between 3 cm and 10 cm, when the plurality of movable nozzle sections are in their retracted positions.

A further example of any of the foregoing fire extinguishing systems, wherein the fire extinguishing nozzle can have a total height of between 5 cm and 8 cm, when the plurality of movable nozzle sections are in their retracted positions.

A further example of any of the foregoing fire extinguishing systems, wherein the fire extinguishing nozzle can have a total height of between 10 cm and 60 cm, when the plurality of movable nozzle sections are in their extended positions.

A further example of any of the foregoing fire extinguishing systems, wherein the fire extinguishing nozzle can have a total height of between 20 cm and 40 cm, when the plurality of movable nozzle sections are in their extended positions.

A further example of any of the foregoing fire extinguishing systems, wherein the fire extinguishing nozzle can have a total height of between 25 cm and 35 cm, when the plurality of movable nozzle sections are in their extended positions.

A further example of any of the foregoing fire extinguishing systems, wherein the fixed nozzle section and the plurality of movable nozzle sections can have a generally cylindrical shape.

A further example of any of the foregoing fire extinguishing systems, wherein the plurality of movable nozzle sections can have a distal nozzle section, which is spaced farthest from the fixed nozzle section when the plurality of movable nozzle sections are in their extended positions.

A further example of any of the foregoing fire extinguishing systems, wherein the distal nozzle section can have a distal end face and a peripheral side face.

A further example of any of the foregoing fire extinguishing systems, wherein at least one first extinguishing agent release opening can be provided on the distal end face.

A further example of any of the foregoing fire extinguishing systems, wherein a plurality of second extinguishing agent release openings can be provided around the peripheral side face.

A further example of any of the foregoing fire extinguishing systems, wherein the total cross-section of the plurality of second extinguishing agent release openings can be at least two times the total cross-section of the at least one first extinguishing agent release opening.

A further example of any of the foregoing fire extinguishing systems, wherein the total cross-section of the plurality of second extinguishing agent release openings can be at least three times the total cross-section of the at least one first extinguishing agent release opening.

A further example of any of the foregoing fire extinguishing systems, wherein the total cross-section of the plurality of second extinguishing agent release openings can be between three times and five times the total cross-section of the at least one first extinguishing agent release opening.

A further example of any of the foregoing fire extinguishing systems, wherein the at least one first extinguishing agent release opening can include between 1 and 20 first extinguishing agent release openings.

A further example of any of the foregoing fire extinguishing systems, wherein the at least one first extinguishing agent release opening can include between 4 and 10 first extinguishing agent release openings.

A further example of any of the foregoing fire extinguishing systems, wherein the plurality of second extinguishing agent release openings can include between 2 and 30 second extinguishing agent release openings.

A further example of any of the foregoing fire extinguishing systems, wherein the plurality of second extinguishing agent release openings can include between 4 and 16 second extinguishing agent release openings.

A further example of any of the foregoing fire extinguishing systems, wherein the plurality of movable nozzle sections can be configured to extend from the fixed nozzle section in a telescoping manner upon receiving a pressurized dry chemical extinguishing agent.

A further example of any of the foregoing fire extinguishing systems, wherein the plurality of movable nozzle sections can be configured to extend from the fixed nozzle section in a telescoping manner upon receiving a pressurized extinguishing agent with an extinguishing agent pressure of at least 15 bar.

A further example of any of the foregoing fire extinguishing systems, wherein the plurality of movable nozzle sections can be configured to extend from the fixed nozzle section in a telescoping manner upon receiving an extinguishing agent pressure of between 15 bar and 30 bar.

A further example of any of the foregoing fire extinguishing systems, wherein the mounting portion can include a mounting plate.

A further example of any of the foregoing fire extinguishing systems, wherein the extinguishing agent connection can be a through hole through the mounting plate.

### Wheeled Land Vehicle

A wheeled land vehicle according to an example embodiment of this disclosure includes, among other possible things, an extinguishing agent reservoir and at least one fire extinguishing nozzle coupled to the extinguishing agent reservoir. The fire extinguishing nozzle includes a mounting portion, an extinguishing agent connection, a fixed nozzle section, and a plurality of moveable nozzle sections. The fixed nozzle section is fixedly mounted to the mounting portion. The plurality of movable nozzle sections are moveable arranged with respect to the fixed nozzle section. The fixed nozzle section and the plurality of moveable nozzle sections form a telescopic nozzle arrangement in which the plurality of movable nozzle sections are configured to extend from the fixed nozzle section in a telescoping manner upon receiving a pressurized extinguishing agent at the extinguishing agent connection.

The wheeled land vehicle of the preceding paragraph can optionally include, additionally and/or alternatively, any one or more of the following features, configurations and/or additional components.

A further example of the foregoing wheeled land vehicle, wherein the at least one fire extinguishing nozzle is arranged on an underbody of the wheeled land vehicle, with a direction of extension of the telescopic nozzle arrangement of the at least one fire extinguishing nozzle being substantially downward from the underbody of the wheeled land vehicle.

A further example of any of the foregoing wheeled land vehicles can include a trigger mechanism configured to establish a respective agent receiving path between the extinguishing agent reservoir and each of the at least one fire extinguishing nozzle.

A further example of any of the foregoing wheeled land vehicles, wherein the mounting portion can mount the fire extinguishing nozzle to an outside portion of a wheeled land vehicle.

A further example of any of the foregoing wheeled land vehicles, wherein the extinguishing agent connection can couple the fire extinguishing nozzle to an extinguishing agent reservoir of a fire extinguishing system.

A further example of any of the foregoing wheeled land vehicles, wherein the plurality of movable nozzle sections can include between 2 and 5 movable nozzle sections.

A further example of any of the foregoing wheeled land vehicles, wherein the plurality of movable nozzle sections can include between 3 and 4 movable nozzle sections.

A further example of any of the foregoing wheeled land vehicles, wherein the mounting portion can mount the fire extinguishing nozzle to an underbody of the wheeled land vehicle.

A further example of any of the foregoing wheeled land vehicles, wherein the plurality of movable nozzle sections can be located inside the fixed nozzle section, when in their retracted positions.

A further example of any of the foregoing wheeled land vehicles, wherein the fire extinguishing nozzle can have a total height of between 3 cm and 10 cm, when the plurality of movable nozzle sections are in their retracted positions.

A further example of any of the foregoing wheeled land vehicles, wherein the fire extinguishing nozzle can have a total height of between 5 cm and 8 cm, when the plurality of movable nozzle sections are in their retracted positions.

A further example of any of the foregoing wheeled land vehicles, wherein the fire extinguishing nozzle can have a total height of between 10 cm and 60 cm, when the plurality of movable nozzle sections are in their extended positions.

A further example of any of the foregoing wheeled land vehicles, wherein the fire extinguishing nozzle can have a total height of between 20 cm and 40 cm, when the plurality of movable nozzle sections are in their extended positions.

A further example of any of the foregoing wheeled land vehicles, wherein the fire extinguishing nozzle can have a total height of between 25 cm and 35 cm, when the plurality of movable nozzle sections are in their extended positions.

A further example of any of the foregoing wheeled land vehicles, wherein the fixed nozzle section and the plurality of movable nozzle sections can have a generally cylindrical shape.

A further example of any of the foregoing wheeled land vehicles, wherein the plurality of movable nozzle sections can have a distal nozzle section, which is spaced farthest from the fixed nozzle section when the plurality of movable nozzle sections are in their extended positions.

A further example of any of the foregoing wheeled land vehicles, wherein the distal nozzle section can have a distal end face and a peripheral side face.

A further example of any of the foregoing wheeled land vehicles, wherein at least one first extinguishing agent release opening can be provided on the distal end face.

A further example of any of the foregoing wheeled land vehicles, wherein a plurality of second extinguishing agent release openings can be provided around the peripheral side face.

A further example of any of the foregoing wheeled land vehicles, wherein the total cross-section of the plurality of second extinguishing agent release openings can be at least two times the total cross-section of the at least one first extinguishing agent release opening.

A further example of any of the foregoing wheeled land vehicles, wherein the total cross-section of the plurality of second extinguishing agent release openings can be at least three times the total cross-section of the at least one first extinguishing agent release opening.

A further example of any of the foregoing wheeled land vehicles, wherein the total cross-section of the plurality of second extinguishing agent release openings can be between three times and five times the total cross-section of the at least one first extinguishing agent release opening.

A further example of any of the foregoing wheeled land vehicles, wherein the at least one first extinguishing agent release opening can include between 1 and 20 first extinguishing agent release openings.

A further example of any of the foregoing wheeled land vehicles, wherein the at least one first extinguishing agent release opening can include between 4 and 10 first extinguishing agent release openings.

A further example of any of the foregoing wheeled land vehicles, wherein the plurality of second extinguishing agent release openings can include between 2 and 30 second extinguishing agent release openings.

A further example of any of the foregoing wheeled land vehicles, wherein the plurality of second extinguishing agent release openings can include between 4 and 16 second extinguishing agent release openings.

A further example of any of the foregoing wheeled land vehicles, wherein the plurality of movable nozzle sections can be configured to extend from the fixed nozzle section in a telescoping manner upon receiving a pressurized dry chemical extinguishing agent.

A further example of any of the foregoing wheeled land vehicles, wherein the plurality of movable nozzle sections can be configured to extend from the fixed nozzle section in a telescoping manner upon receiving a pressurized extinguishing agent with an extinguishing agent pressure of at least 15 bar.

A further example of any of the foregoing wheeled land vehicles, wherein the plurality of movable nozzle sections can be configured to extend from the fixed nozzle section in a telescoping manner upon receiving an extinguishing agent pressure of between 15 bar and 30 bar.

A further example of any of the foregoing wheeled land vehicles, wherein the mounting portion can include a mounting plate.

A further example of any of the foregoing wheeled land vehicles, wherein the extinguishing agent connection can be a through hole through the mounting plate.

### A Method of Applying a Fire Extinguishing Agent

A method of applying a fire extinguishing agent to an outside environment of a wheeled land vehicle according to an example embodiment of this disclosure includes, among other possible steps, providing a pressurized extinguishing agent to a fire extinguishing nozzle, which comprises a fixed nozzle section and a plurality of movable nozzle sections. The method includes, as a response to receiving the pressurized extinguishing agent, extending the plurality of movable nozzle sections from the fixed nozzle section in a telescoping manner. The method includes releasing the pressurized extinguishing agent from the fire extinguishing nozzle, which includes releasing the pressurized extinguishing agent from a distal nozzle section. The distal nozzle section is spaced farthest from the fixed nozzle section when the plurality of movable nozzle sections are in their extended positions.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire extinguishing nozzle for a fire extinguishing system of a wheeled land vehicle, the fire extinguishing nozzle comprising:
a mounting portion for mounting the fire extinguishing nozzle to an outside portion of the wheeled land vehicle;
an extinguishing agent connection for coupling the fire extinguishing nozzle to an extinguishing agent reservoir of the fire extinguishing system;
a fixed nozzle section, fixedly mounted to the mounting portion; and
a plurality of movable nozzle sections, movably arranged with respect to the fixed nozzle section;
wherein the fixed nozzle section and the plurality of movable nozzle sections form a telescopic nozzle arrangement, wherein the plurality of movable nozzle sections are configured to extend from the fixed nozzle section in a telescoping manner upon receiving a pressurized extinguishing agent at the extinguishing agent connection.

2. The fire extinguishing nozzle of claim 1, wherein the plurality of movable nozzle sections includes between 2 and 5 movable nozzle sections.

3. The fire extinguishing nozzle according to claim 1, wherein the plurality of movable nozzle sections is located inside the fixed nozzle section, when each moveable nozzle section of the plurality of nozzles sections is in a retracted position.

4. The fire extinguishing nozzle of claim 3, wherein the fire extinguishing nozzle has a total height of between 3 cm and 10 cm, when each moveable nozzle section of the plurality of movable nozzle sections is in the retracted position.

5. The fire extinguishing nozzle of claim 3, wherein the fire extinguishing nozzle has a total height of between 10 cm and 60 cm, when each moveable nozzle section of the plurality of movable nozzle sections is in the extended position.

6. The fire extinguishing nozzle of claim 1, wherein the fixed nozzle section and the plurality of movable nozzle sections have a generally cylindrical shape.

7. The fire extinguishing nozzle of claim 1,
wherein the plurality of movable nozzle sections have a distal nozzle section, which is spaced farthest from the fixed nozzle section when the plurality of movable nozzle sections are in their extended positions;
wherein the distal nozzle section has a distal end face and a peripheral side face; and
wherein at least one first extinguishing agent release opening is provided on the distal end face and a plurality of second extinguishing agent release openings are provided around the peripheral side face.

8. The fire extinguishing nozzle according to claim 7, wherein the total cross-section of the plurality of second extinguishing agent release openings is at least two times the total cross-section of the at least one first extinguishing agent release opening.

9. The fire extinguishing nozzle according to claim 7, wherein the total cross-section of the plurality of second extinguishing agent release openings is at least three times the total cross-section of the at least one first extinguishing agent release opening.

10. The fire extinguishing nozzle according to claim 7, wherein the total cross-section of the plurality of second extinguishing agent release openings is between three times and five times the total cross-section of the at least one first extinguishing agent release opening.

11. The fire extinguishing nozzle according to claim 7,
wherein the at least one first extinguishing agent release opening comprises between 1 and 20 first extinguishing agent release openings

12. The fire extinguishing nozzle according to claim 7, wherein the plurality of second extinguishing agent release openings comprises between 2 and 30 second extinguishing agent release openings.

13. The fire extinguishing nozzle of claim 1,
wherein the plurality of movable nozzle sections are configured to extend from the fixed nozzle section in a telescoping manner upon receiving a pressurized dry chemical extinguishing agent.

14. The fire extinguishing nozzle of claim 1,
wherein the plurality of movable nozzle sections are configured to extend from the fixed nozzle section in a telescoping manner upon receiving a pressurized extinguishing agent with an extinguishing agent pressure of at least 15 bar.

15. The fire extinguishing nozzle of claim 1,
wherein the plurality of movable nozzle sections are configured to extend from the fixed nozzle section in a telescoping manner upon receiving an extinguishing agent pressure of between 15 bar and 30 bar.

16. The fire extinguishing nozzle of claim 1, wherein the mounting portion comprises a mounting plate, and wherein the extinguishing agent connection is a through hole through the mounting plate.

17. A fire extinguishing system for a wheeled land vehicle, comprising:
an extinguishing agent reservoir; and
at least one fire extinguishing nozzle coupled to the extinguishing agent reservoir, the fire extinguishing nozzle comprising:
a mounting portion for mounting the fire extinguishing nozzle to an outside portion of the wheeled land vehicle;
an extinguishing agent connection for coupling the fire extinguishing nozzle to an extinguishing agent reservoir of the fire extinguishing system;
a fixed nozzle section, fixedly mounted to the mounting portion; and
a plurality of movable nozzle sections, movably arranged with respect to the fixed nozzle section;
wherein the fixed nozzle section and the plurality of movable nozzle sections form a telescopic nozzle arrangement, wherein the plurality of movable nozzle sections are configured to extend from the fixed nozzle section in a telescoping manner upon receiving a pressurized extinguishing agent at the extinguishing agent connection.

18. The fire extinguishing system according to claim 17, further comprising a trigger mechanism configured to establish a respective agent receiving path between the extinguishing agent reservoir and each of the at least one fire extinguishing nozzle.

19. A wheeled land vehicle comprising:
an extinguishing agent reservoir; and
at least one fire extinguishing nozzle coupled to the extinguishing agent reservoir and arranged on one or more outside portions of the wheeled land vehicle, the fire extinguishing nozzle comprising:
a mounting portion for mounting the fire extinguishing nozzle to the outside portion of the wheeled land vehicle;
an extinguishing agent connection for coupling the fire extinguishing nozzle to an extinguishing agent reservoir of the fire extinguishing system;
a fixed nozzle section, fixedly mounted to the mounting portion; and
a plurality of movable nozzle sections, movably arranged with respect to the fixed nozzle section;
wherein the fixed nozzle section and the plurality of movable nozzle sections form a telescopic nozzle arrangement, wherein the plurality of movable nozzle sections are configured to extend from the fixed nozzle section in a telescoping manner upon receiving a pressurized extinguishing agent at the extinguishing agent connection.

20. The wheeled land vehicle according to claim 19, wherein the at least one fire extinguishing nozzle is arranged on an underbody of the wheeled land vehicle, with a direction of extension of the telescopic nozzle arrangement of the at least one fire extinguishing nozzle being substantially downward from the underbody of the wheeled land vehicle.
